(19) United States
(12) Patent Application Publication
(10) Pub. No.: US 2015/0369433 A1
(43) Pub. Date: Dec. 24, 2015

(54) SELF-POWERED e-PAPER DISPLAY

(71) Applicant: 3M INNOVATIVE PROPERTIES COMPANY, Saint Paul, MN (US)

(72) Inventors: Jingfei CHEN, Shanghai (CN); Guanglei DU, Beijing (CN); John A. WHEATLEY, Lake Elmo, MN (US); Andrew J. OUDERKIRK, St. Paul, MN (US)

(21) Appl. No.: 14/766,600

(22) PCT Filed: Feb. 3, 2014
(86) PCT No.: PCT/US14/14470

§ 371 Date: Aug. 7, 2015

Related U.S. Application Data
(60) Provisional application No. 61/762,076, filed on Feb. 7, 2013.

(51) Int. Cl. F21S 9/00; F21V 7/04; F21V 13/08; G02B 5/18

(52) U.S. Cl. CPC F21S 9/00; G02B 5/1861; F21V 7/04; F21V 13/08

(57) ABSTRACT

A display device is provided that includes a photovoltaic cell, a dichroic reflector adjacent to the photovoltaic cell, and a low refractive index layer adjacent to the dichroic reflector. The low refractive index layer can have an index of refraction of from about 1.1 to about 1.4.

### TECHNICAL FIELD

The provided disclosure relates to electronic display devices that can be self-powered by photovoltaic cells.

### BACKGROUND

Electronic display devices such as e-readers, that include electronic paper displays, are being used by a large range of users for a wide variety of applications. These devices are typically powered by rechargeable batteries, such as lithium-ion cells. The life of a battery is very important to users. A short battery life can be detrimental to the commercial viability of any products that include such devices.

Solar cells or solar panels are photovoltaic devices that can represent a supplemental or alternative source of energy for electronic display devices. Some electronic display devices can have sufficiently low power needs and may have sufficiently large available surface areas that they may be able to be powered entirely by one or more solar cells, particularly when used in lighting conditions.

### SUMMARY

In order to take advantage of the large surface area of electronic displays, it would be desirable to have a solar cell underneath such a display rather than on its surface. If a solar cell is located on the surface of an electronic display it can block some of the visible area of the display. If the solar cell is located underneath the electronic display, it can utilize the whole area of the display for energy collection.

However, placing the solar cell under the electronic display requires that the visible portions of the display reflect visible light while other wavelengths which can power the solar cell are allowed to pass through the display with low attenuation. Additionally, in some configurations, the solar cell or photovoltaic device can be visible in the display. Normal optically diffusive layers and/or diffusing plates can be used in the display to hide the visibility of the solar cell, but these optically diffusive layers also can reduce the efficiency of the solar cell. Thus, there is a need for electronic displays that can be powered by solar cells and that can present an aesthetic, readable, display image to the end user.

In one aspect, a display device is provided that includes a photovoltaic cell, a dichroic reflector adjacent to the photovoltaic cell, and a low refractive index layer adjacent to the dichroic reflector, where the low refractive index layer has a refractive index of between about 1.1 to about 1.4. In some embodiments, the dichroic reflector includes multiple polymeric layers and can be tuned so that it has a transmission of greater than 75% for wavelengths of electromagnetic radiation greater than about 750 nm to about 2000 nm along with a reflection of greater than about 95% for wavelengths of electromagnetic radiation between 400 nm and 750 nm. In some embodiment, the display panel includes a patterned layer comprising a phosphor and in other embodiments the display panel can include a shutter layer. In some embodiments, the display device includes an optically diffusive layer.

In another aspect, a display device is provided that includes a photovoltaic cell, a dichroic reflector adjacent to the photovoltaic cell, a low refractive index layer adjacent to the dichroic reflector, and a phosphor layer, a dye layer, an absorbing ink layer, or a diffusive layer optically coupled to the low refractive index layer. The photovoltaic cell can include silicon and the dichroic reflector can include multiple polymeric layers. The dichroic reflector can include an optically diffusive layer and a low refractive index layer.

In yet another aspect, a display device is provided that includes a photovoltaic cell, a dichroic reflector adjacent to the photovoltaic cell, where the dichroic reflector has a reflective cutoff wavelength edge, and a patterned display panel adjacent to the dichroic reflector, where the patterned display panel includes a phosphor having a visible emission peak. The reflective cutoff wavelength edge of the dichroic reflector substantially overlaps the visible emission peak of the phosphor up to 750 nm.

In this disclosure:

“adjacent” refers to layers that are in proximity to each other, usually in contact with each other, but may have an intervening layer between them;

“cutoff” refers to the wavelength of the inflection point of the curve of the change in transmission or reflection of a dichroic filter; and

“dichroic reflector” refers to a film or a layer of films that act as a spectrally selective reflector and may include additional elements such as a diffuse layer and a low refractive index layer.

In some embodiments, the provided electronic display devices have a solar cell underneath the electronic display device rather than on its surface. Placing the solar cell under the electronic display allows the visible portions of the display reflect visible light while other wavelengths which can power the solar cell are allowed to pass through the display with low attenuation. The provided display devices can be powered by solar cells and that can present an aesthetic, readable, display image to the end user.

The above summary is not intended to describe each disclosed embodiment of every implementation of the present disclosure. The brief description of the drawings and the detailed description which follows more particularly exemplify illustrative embodiments.

### BRIEF DESCRIPTION OF THE DRAWINGS

Throughout the specification reference is made to the appended drawings, where like reference numerals designate like elements, and wherein:

FIGS. 1a and 1b are graphs of the transmission vs. wavelength and the reflectance vs. wavelength of a dichroic filter useful in an embodiment of the provided display devices.

FIGS. 2-13 are schematic cross-section views of possible constructions of display devices and are embodiments of the provided display device.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Electronic display devices, such as e-books, are increasingly being used by consumers due to their light weight, portability, and ability to download reading material. One of the challenges of such display devices is to present an image to the reader that is very similar to that in a book or magazine requiring the images to be on a “white” background resembling paper. Some electronic readers (e-readers) utilize a lighted backplane for the “white” background. But lighted backplanes require a constant energy source, typically a rechargeable battery, which can limit the reading time of the device between charges. Additionally, other powered components in an e-reader, such as wireless communications or image control electronics also require energy and can limit the reading time of the device between charges. What is needed is an electronic display device that can recharge itself while it is being used.

The provided electronic display devices include a photovoltaic cell or photovoltaic solar cell. Exemplary materials for use as photovoltaic solar cells in the provided electronic displays are displayed in Table 1 below.

TABLE 1
Photovoltaic Cell Materials

| Cell Active Material | Response Spectrum (nm) | IR Response |
|---|---|---|
| Crystal Si | 300-1300 | Strong |
| Amorphous Si | 300-800 | None |
| Copper indium gallium | 300-1300 | Strong |
| (di)selenide | | |
| CdTe | 400-900 | Weak |
| GaAs | 300-900 | Weak |
| Dye Sensitized Solar Cell | 300-800 | None |
| (DSSC) | | |
| Organic Solar Cell | 400-800 | None |
| Multijunction Solar Cell | 300-1300 | Strong |

For use in the provided electronic display devices, the photovoltaic solar cell needs to absorb infrared (IR) radiation. However, if a reflector is used that shifts the infrared cutoff to a wavelength of phosphor emission, such as 650 nm, any of the cell active materials listed in Table 1 could theoretically be useful. Even if the IR cutoff wavelengths are in the normal IR range, i.e. >750 nm, the cell active materials listed in Table 1 can all output some power, though it may be very low in some cases. Some low absorbing photovoltaics, such as DSSC, may not produce much power where, for example, the IR transmission cutoff is about 800 nm. But some of these may be useful where the spectrally selective reflective cutoff is tuned to be close to the phosphor emission peak.

Photovoltaic solar cells are, typically, made from inorganic materials that can include monocrystalline silicon, polycrystalline silicon, amorphous silicon, cadmium telluride, or copper indium selenide/sulfide. Many currently available photovoltaic solar cells can be made from bulk materials that are cut into wafers between 180 to 240 micrometers thick that are then processed like other semiconductors. Other photovoltaic solar cells can be made from thin-films or layers of, for example, organic dyes, and organic polymers deposited on supporting substrates. A third group of materials useful in photovoltaic solar cells can be made from nanocrystals and used as quantum dots (electron-confined nanoparticles). Silicon remains the only material that is known to be useful in both bulk and thin-film forms. Silicon thin-film cells are mainly deposited by chemical vapor deposition (typically plasma-enhanced, PE-CVD) from silane gas and hydrogen gas. Depending on the deposition parameters amorphous silicon, protocrystalline silicon, or nanocrystalline silicon, also called microcrystalline silicon can be produced. An amorphous silicon solar cell is made of amorphous or microcrystalline silicon and its basic electronic structure is the p-i-n junction. Amorphous silicon is attractive as a solar cell material because it is abundant and non-toxic (unlike its CdTe counterpart) and can require a low processing temperature, enabling production of devices to occur on flexible and low-cost substrates. As the amorphous structure has a higher absorption rate of light than crystalline cells, the complete light spectrum can be absorbed with a very thin layer of photo-electrically active material. Amorphous silicon has a higher bandgap (1.7 eV) than crystalline silicon (1.1 eV), which means it absorbs the visible part of the solar spectrum more strongly than the infrared portion of the spectrum.

Dye-sensitized solar cells (DSSCs) are made of low-cost materials and do not need elaborate equipment to manufacture and can be significantly less expensive than solid-state cell designs. DSSC's can be engineered into flexible sheets although their conversion efficiency (light to electricity ratio) is, typically, less than the thin film cells. Typically, a ruthenium organometallic dye (Ru-centered) is used as a monolayer of light-absorbing material. The dye-sensitized solar cell can depend upon a mesoporous layer of nanoparticulate titanium dioxide to greatly amplify the surface area (200-300 m²/g TiO₂, as compared to approximately 10 m²/g of flat single crystal). The photo-generated electrons from the light absorbing dye are passed on to the n-type TiO₂, and the holes are absorbed by an electrolyte on the other side of the dye. The circuit can be completed by a redox couple in the electrolyte, which can be liquid or solid. This type of photovoltaic solar cell can support a more flexible use of materials, and can be manufactured by screen printing or use of ultrasonic nozzles, with the potential for lower processing costs than those used for bulk solar cells. However, the dyes in these cells can suffer from degradation under heat and UV light, and the cell casing required for these cells is difficult to seal due to the solvents used in assembly.

Quantum dot solar cells (QDSCs) employ low band gap semiconductor nanoparticles, fabricated with such small crystallite sizes that they form quantum dots (such as CdS, CdSe, Sb₂S₃, PbS, etc.), instead of organic or organometallic dyes as light absorbers. Quantum dots (QDs) have attracted much interest because of their unique properties. Their size quantization allows for the band gap to be tuned by simply changing particle size.

The provided electronic display devices include a dichroic reflector adjacent to the photovoltaic cell. In some embodiments, the dichroic reflector is disposed upon and in contact with the photovoltaic cell. The dichroic reflector reflects visible wavelengths of light while transmitting a substantial portion of infrared wavelengths. The dichroic reflector can include an uneven number of absorption-free layers of high and low refracting dielectric materials applied alternately to a glass substrate. Zinc sulfide and magnesium fluoride are two commonly-used dielectric materials. Typically, these multilayer inorganic dichroic reflectors can be produced by high vacuum disposition.

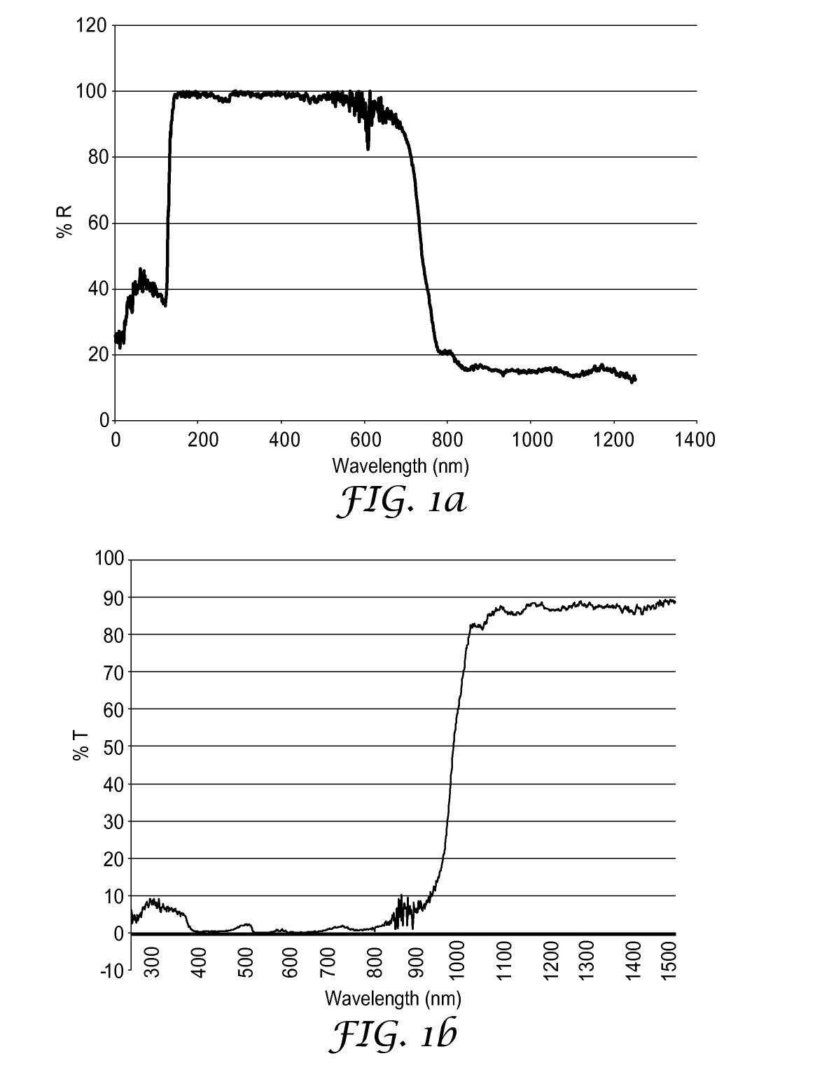

In some embodiments, the dichroic reflector can include polymer-based multilayer films or inorganic multilayer coatings based upon light interference. For example, the dichroic reflector can be a multilayer coating including one or more Ta₂O₅ (higher index) and one or more SiO₂ (lower index) layers to reflect specific designed wavelengths. In some other embodiments, the dichroic reflector can include a number of alternating layers of at least first and second diverse polymeric materials such that at least 50% of the peak visible light of a wavelength of between about 400 nm and 750 nm incident on the mirror is reflected and at least 50% of peak infrared light between about 750 nm and 2000 nm is transmitted. The reflection and transmission spectra of an exemplary dichroic reflector useful in the provided display devices is shown in FIGS. 1a and 1b respectively. The dichroic reflector in FIG. 1a has a visible reflection of about 98.8% (averaged over the visible region of the spectrum). The cutoff is around 750 nm. FIG. 1b shows that the dichroic reflector also has an average transmission of 87.3% between the wavelengths of 1090 nm and 1500 nm. These all-polymeric dichroic reflectors are lower cost to produce than vacuum deposited reflectors and may be formed, shaped, or bent into a variety of complex shapes. Typically, the polymers chosen have a refractive index mismatch of at least 0.03. The dichroic reflector may comprise alternating layers of a wide variety of generally transparent thermoplastic materials. Suitable thermoplastic resins, along with representative refractive indices, which may be used in the practice of the present disclosure include, but are not limited to: perfluoroalkoxy resins (refractive index=1.35), polytetrafluoroethylene (1.35), fluorinated ethylene-propylene copolymers (1.34), silicone resins (1.41), polyvinylidene fluoride (1.42), polychlorotrifluoroethylene (1.42), epoxy resins (1.45), poly(butyl acrylate) (1.46), poly(4-methylpentene-1) (1.46), poly(vinyl acetate) (1.47), ethyl cellulose (1.47), polyformaldehyde (1.48), polyisobutyl methacrylate (1.48), polymethyl acrylate (1.48), polypropyl methacrylate (1.48), polyethyl methacrylate (1.48), polyether block amide (1.49), polymethyl methacrylate (1.49), cellulose acetate (1.49), cellulose propionate (1.49), cellulose acetate butyrate (1.49), cellulose nitrate (1.49), polyvinyl butyral (1.49), polypropylene (1.49), polybutylene (1.50), ionomeric resins such as SURLYN (1.51), low density polyethylene (1.51), polyacrylonitrile (1.51), polyisobutylene (1.51), thermoplastic polyesters such as ECDEL (1.52), natural rubber (1.52), PERBUNAN (1.52), polybutadiene (1.52), nylon (1.53), polyacrylic imides (1.53), poly(vinyl chloro acetate) (1.54), polyvinyl chloride (1.54), high density polyethylene (1.54), copolymers of methyl methacrylate and styrene such as ZERLON (1.54), transparent acrylonitrile-butadiene-styrene terpolymer (1.54), allyl diglycol resin (1.55), blends of polyvinylidene chloride and polyvinyl chloride such as SARAN resins (1.55), polyalpha-methyl styrene (1.56), styrene-butadiene latexes such as Dow 512-K (1.56), polyurethane (1.56), neoprene (1.56), copolymers of styrene and acrylonitrile such as TYRIL resin (1.57), copolymers of styrene and butadiene (1.57), polycarbonate (1.59), other thermoplastic polyesters such as polyethylene terephthalate and polyethylene terephthalate glycol (1.60), polystyrene (1.60), polyimide (1.61), polyvinylidene chloride (1.61), polydichlorostyrene (1.62), polysulfone (1.63), polyether sulfone (1.65), and polyetherimide (1.66). The refractive indices reported above may vary somewhat at different wavelengths. For example, the refractive index of polycarbonate is somewhat greater for light in the blue region of the spectrum and somewhat lower for light in the red region of the spectrum.

Copolymers of the above resins can also be useful such as ethylene and vinyl alcohol, styrene and 2-hydroxyethylacrylate, styrene and maleic anhydride, styrene-butadiene block copolymers, styrene and methylmethacrylate, and styrene and acrylic acid. Other useful polymeric materials include polyetheretherketones (PEEK), polybutene, maleic anhydride grafted polyolefins, and copolymers of ethylene and vinyl acetate. Useful materials to produce polymeric spectrally selective reflectors are disclosed, for example, in U.S. Pat. Nos. 5,122,905 and 5,393,198 (both Wheatley et al.). Typically, multilayer spectrally selective reflectors can be formed by lamination or multilayer co-extrusion.

In some applications, it may be desirable to tune the wavelength reflectivity of the dichroic reflectors. For example, it might be desirable for the dichroic reflectors to absorb (have low transmission) certain wavelengths of ultraviolet radiation. In an e-reader, for example, it can be advantageous for the dichroic reflector to absorb lower wavelengths of ultraviolet radiation so that these wavelengths are not reflected into the viewers' eyes where they can do damage. However, ultraviolet absorbers, if they absorb too close to the edge of the visible spectrum, can change the visible wavelength reflection transmission of the reflector so that the display has a yellow tint. Similarly, in applications such as the present one that includes a photovoltaic solar cell behind the dichroic reflector, it can be desirable to have infrared radiation (750 nm to 2000 nm) pass through the dichroic reflector and reach the photovoltaic solar cell. However, if the dichroic reflector absorbs too close to the high wavelength end of the visible spectrum it can impart a bluish tinge to the reflected light. The blue edge and the red edge of the transmission spectrum of multilayer reflectors can be sharpened by monotonically varying the thickness of an optical repeating unit along multilayer films as disclosed in U.S. Pat. No. 6,157,490 (Wheatley et al.). A typical spectrally reflective film useful in the provided electronic display devices can be an Enhanced Specular Reflector (ESR), available from 3M, St. Paul, Minn.

The provided dichroic reflectors need not be diffusive, but diffuse reflection may improve the visual image to the user. For this reason, the dichroic reflector can either be a spectrally selective reflector (e.g., enhanced specular reflector) or it can be a stack of a low refractive index layer, a diffusive layer, or both adjacent to the spectrally selective reflector. In some embodiments, the low refractive index layer can include diffusive elements.

The dichroic reflector does not need to be laminated onto the photovoltaic cell. If the dichroic reflector is laminated, an optically clear adhesive which is either a pressure-sensitive adhesive (PSA) or a liquid adhesive can be used. Generally, these optically clear adhesives can be acrylic, rubber, silicone, polyester, epoxy or acrylic ester and are all transparent to visible and infrared wavelengths of actinic radiation without any colored additives, which may be present depending upon the application.

The provided electronic display device can include a low refractive index layer adjacent to the dichroic reflector. The low refractive index layer can include air, a gel, fumed silica, an aerogel, or other nanoporous transparent structures, either open cell structures or closed cell structures. The low refractive index layer can include a seal layer or can be adhesive coated, typically with an optically clear adhesive. The low refractive index layer can also include an air layer that may have some structural elements to keep the air layer separate from the other layers. These structural elements can include spacing beads, surface haze, or microreplicated features such as posts or poles. A prism structure on the reflector can also be used to provide for an air gap in the provided electronic display devices.

The low refractive index layer can have a refractive index of 1.4 or less, 1.3 or less, 1.25 or less, 1.2 or less, 1.15 or less, 1.1 or less, or even 1.05 or less. In some embodiments, the low refractive index layer can be air. In other embodiments, such as those disclosed in U.S. Pat. Appl. Publ. No. 2012/0038990 (Hao et al.), the low refractive index layer can include a plurality of voids dispersed in a binder. The voids can have an index of refraction nᵥ and a permittivity ∈ᵥ, where nᵥ²=∈ᵥ, and the binder can have an index of refraction n_{b} and a permittivity ∈_{b}, where n_{b}²=∈_{b}.

In general, the interaction of a low refractive index layer with light, such as light that is incident on, or propagates in, the low refractive index layer, can depend upon a number of film or layer characteristics such as, for example, the film or layer thickness, the binder refractive index, the void or pore refractive index, the pore shape and size, the spatial distribution of the pores, and the wavelength of light. In some embodiments, light that is incident on or propagates within the low refractive index layer “sees” or “experiences” an effective permittivity ∈_{eff} and an effective index n_{eff}, where n_{eff} can be expressed in terms of the void index nᵥ, the binder index n_{b}, and the void porosity or volume fraction “f”

In such embodiments, the optical film or low refractive index layer is sufficiently thick and the voids are sufficiently small so that light cannot resolve the shape and features of a single or isolated void. In such embodiments, the size of at least a majority of the voids, such as at least 60% or 70% or 80% or 90% of the voids, is not greater than about λ/5, or not greater than about λ/6, or not greater than about λ/8, or not greater than about λ/10, or not greater than about λ/20, where λ is the wavelength of light. In some embodiments, some of the voids can be sufficiently small so that their primary optical effect is to reduce the effective index, while some other voids can reduce the effective index and scatter light, while still some other voids can be sufficiently large so that their primary optical effect is to scatter light.

In some embodiments, the light that is incident on the low refractive index layer can be visible light, meaning that the wavelength of the light is in the visible range of the electromagnetic spectrum. In these embodiments, the visible light can have a wavelength that is in a range of from about 380 nm to about 750 nm, or from about 400 nm to about 700 nm, or from about 420 nm to about 680 nm. In these embodiments, the low refractive index layer can have an effective index of refraction and can include a plurality of voids if the size of at least a majority of the voids, such as at least 60% or 70% or 80% or 90% of the voids, is not greater than about 70 nm, or not greater than about 60 nm, or not greater than about 50 nm, or not greater than about 40 nm, or not greater than about 30 nm, or not greater than about 20 nm, or not greater than about 10 nm.

In some embodiments, the low refractive index layer can be sufficiently thick so that the low refractive index layer can have an effective index that can be expressed in terms of the indices of refraction of the voids and the binder, and the void or pore volume fraction or porosity. In such embodiments, the thickness of the low refractive index layer can be not less than about 1 micrometer, or not less than about 2 micrometers, or in a range from 1 to 20 micrometers. When the voids in a disclosed low refractive index layer are sufficiently small and the low refractive index layer is sufficiently thick, the low refractive index layer can have an effective permittivity ∈_{eff} that can be expressed as:

∈_{eff}=f ∈ᵥ+(1−f)∈_{b}.

In these embodiments, the effective index n_{eff} of the optical film or low refractive index layer can be expressed as:

n_{eff}²=fnᵥ²+(1−f)n_{b}²

In some embodiments, such as when the difference between the indices of refraction of the pores and the binder is sufficiently small, the effective index of the low refractive index layer can be approximated by the following expression:

n_{eff}=fnᵥ+(1−f)n_{b}

In these embodiments, the effective index of the low refractive index layer is the volume weighted average of the indices of refraction of the voids and the binder. Under ambient conditions, the voids can contain air, and thus the refractive index nᵥ for the voids can be the refractive index of air or approximately 1.00.
For example, a low refractive index layer that has a void volume fraction of about 50% and a binder that has an index of refraction of about 1.5 can have an effective index of about 1.25. In some embodiments, the effective index of refraction of the low refractive index layer can be not greater than (or is less than) about 1.3, or less than about 1.25, or less than about 1.2, or less than about 1.15, or less than about 1.1. In some embodiments, the refractive index can be between about 1.14 and about 1.30. In some embodiments, the low refractive index layer can include a binder, a plurality of particles, and a plurality of interconnected voids or a network of interconnected voids. In other embodiments, the low refractive index layer can include a binder and a plurality of interconnected voids or a network of interconnected voids.

A plurality of interconnected voids or a network of interconnected voids can be imparted into low refractive index layers by a number of methods. In one process, the inherent porosity of highly structured, high surface area fumed metal oxides, such as fumed silica oxides, can be exploited in a mixture of binder to form a composite structure that combines binder, particles, voids and, optionally, crosslinkers or other adjuvant materials. The desirable binder to particle ratio can be dependent upon the type of process used to form the interconnected voided structure. While a binder resin is not a prerequisite for the porous fumed silica structure to form, it is typically desirable to incorporate some type of polymeric resin or binder in with the metal oxide network to improve the processing, coating quality, adhesion and durability of the final construction.

Examples of useful binder resins are those derived from thermosetting, thermoplastic and UV curable polymers. Examples include polyvinylalcohol, (PVA), polyvinylbutyral (PVB), polyvinyl pyrrolidone (PVP), polyethylene vinyl acetate copolymers (EVA), cellulose acetate butyrate (CAB) polyurethanes (PURs), polymethylmethacrylate (PMMA), polyethylene oxide, polypropylene oxide, polyacrylates, epoxies, silicones and fluoropolymers, or a combination thereof. The binders could be soluble in an appropriate solvent such as water, ethyl acetate, acetone, 2-butone, isopropyl alcohol, methyl ethyl ketone, and the like, or they could be used as dispersions or emulsions. Examples of some commercially available binders useful in the mixtures are those available from Kuraray-USA, Wacker Chemical, Dyneon LLC, and Rohm and Haas.

Although the binder can be a polymeric system, it can also be added as a polymerizable monomeric system, such as a UV, or thermally curable or crosslinkable system. Examples of such systems can be UV polymerizable acrylates, methacrylates, multi-functional acrylates, urethane-acrylates, and mixtures thereof. Some typical examples can be 1,6 hexane diol diacrylate, trimethylol propane triacrylate, pentaerythritol triacryalate. Such systems are readily available from suppliers such as Neo Res (Newark, Del.), Arkema (Philadelphia, Pa.), or Sartomer (Exton, Pa.). Actinic radiation such as electron beam (E-beam), gamma and UV radiation are useful methods to initiate the polymerization of these systems, with many embodiments utilizing UV active systems. Other useful binder systems can also be cationically polymerized, such systems are available as vinyl ethers and epoxides.

The polymeric binders can also be formulated with cross linkers that can chemically bond with the polymeric binder to form a crosslinked network. Although the formation of crosslinks is not a prerequisite for the formation of the porous structure or the low refractive index optical properties, it is often desirable for other functional reasons such as to improve the cohesive strength of the coating, adhesion to the substrate or moisture, or thermal and solvent resistance. The specific type of crosslinker is dependent upon the binder used. Typical exemplary crosslinkers for polymeric binders such as PVA can be diisocyanates, titantates such as TYZOR-LA (available from DuPont, Wilmington, Del.), poly(epichlorhydrin)amide adducts such as POLYCUP 172, (available from Hercules, Wilmington, Del.), multi-functional aziridines such as CX100 (available from Neo-Res, Newark, Del.), and boric acid, diepoxides, and diacids. The polymeric binders may form a separate phase with the particle aggregates or may be inter-dispersed between the particle aggregates in a manner to “bind” the aggregates together into a structures that connect with the metal oxide particles through direct covalent bond formation or molecular interactions such as ionic, dipole, van Der Waals forces, hydrogen bonding and physical entanglements with the metal oxides.

Exemplary particles useful in low refractive index coatings include fumed metal oxides or pyrogenic metal oxides, such as, for example, fumed silica or alumina. In some embodiments, particles that are highly branched or structured may be used. Such particles can prevent efficient packing in the binder matrix and allow interstitial voids or pores to form. Exemplary materials include highly branched or structured particles include CABO-SIL fumed silica or silica dispersions, such as, for example, those sold under trade designations EH5, TS 520, or pre-dispersed fumed silica particles such as those available as CABO-SPERSE PG 001, PG 002, PG 022, 1020K, 4012K, 1015 (available form Cabot Corporation). Fumed alumina oxides can also be useful structured particles to form a low refractive index system although typically silica is utilized since it has an inherently lower skeletal refractive index than alumina Examples of alumina oxide are available under the trade name CABO-SPERSE, such as, for example, those sold under the trade designation CABO-SPERSE PG003 or CABOT SPEC-Al. In some embodiments, aggregates of these exemplary fumed metal oxides include a plurality of primary particles in the range of about 8 nm to about 20 nm and form a highly branched structure with a wide distribution of sizes ranging from about 80 nm to greater than 300 nm. In some embodiments, these aggregates pack randomly in a unit volume of a coating to form a mesoporous structure with complex bi-continuous network of channels, tunnels, and pores which entrap air in the network and thus lower the density and refractive index of the coating. Other exemplary porous materials can be derived from naturally occurring inorganic materials such as clays, barium sulfates, alumina, and silicates.

Fumed silica particles can also be treated with a surface treatment agent. Surface treatment of the metal oxide particles can provide, for example, improved dispersion in the polymeric binder, altered surface properties, enhanced particle-binder interactions, and/or reactivity. In some embodiments, the surface treatment can stabilize the particles so that the particles are well dispersed in the binder, resulting in a substantially more homogeneous composition. The incorporation of surface modified inorganic particles can be tailored, for example, to enhance covalent bonding of the particles to the binder, thereby providing a more durable and more homogeneous polymer/particle network.

The type of treatment agent can be determined, in part, by the chemical nature of the metal oxide surface. Silanes are typically used for silica and other for siliceous fillers. In the case of silanes, it can be typical to react the silanes with the particle surface before incorporation into the binder. The required amount of surface modifier can be dependent upon several factors such as, for example, particle size, particle type, modifier molecular weight, and/or modifier type. The silane modifier can have reactive groups that form covalent bonds between particles and the binder, such as, for example, carboxy, alcohol, isocynanate, acryloxy, epoxy, thiol or amines. Conversely, the silane modifier can have non-reactive groups, such as, for example, alkyl, alkloxy, phenyl, phenyloxy, polyethers, or mixtures thereof. Such non-reactive groups may modify the surface of the coatings to improve, for example, soil and dirt resistance or to improve static dissipation. Commercially available examples of a surface modified silica particle include, for example, CABO-SI TS 720 and TS 530. It may sometimes be desirable to incorporate a mixture of functional and non-function groups on the surface of the particles to obtain a combination of these desirable features. Representative embodiments of surface treatment agents suitable for use in the compositions of the present disclosure include, for example, N-(3-triethoxysilylpropyl) methoxyethoxyethoxyethyl carbamate, N-(3-triethoxysilylpropyl) methoxyethoxyethoxyethyl carbamate, 3-(methacryloyloxy)propyltrimethoxysilane, 3-acryloxypropyltrimethoxysilane, 3-(methacryloyloxy)propyltriethoxysilane, 3-(methacryloyloxy) propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxyl)ethoxy]acetic acid (MEEAA), β-carboxyethylacrylate (BCEA), 2-(2-methoxyethoxyl)acetic acid, methoxyphenyl acetic acid, and mixtures thereof.

Particle volume concentration (PVC) and critical particle volume concentration (CPVC) can be used to characterize the porosity of the particle binder system used to make the coating. The terms PVC and CPVC are well defined terms in the paint and pigment literature and are further defined in frequently referenced articles and technical books, such as, for example Paint Flow and Pigment Dispersion, Patton, T. C., 2^{nd} Edition, J. Wiley Interscience, 1978, Chapter 5, p. 126 and Modeling Cluster Voids and Pigment Distribution to Predict Properties and CPVC in Coatings. Part 1: Dry Coating Analysis and Sudduth, R. D; Pigment and Resin Technology, 2008, 37(6), p. 375. When the volume concentration of the particles is larger than CPVC, the coating is porous since there is not enough binder to fill all the gaps between the particles and the interstitial regions of the coating. The coating then becomes a mixture of binder, particles, and voids. The volume concentration at which this occurs is related to particle size and particle structure wetting and/or shape. Formulations with volume concentrations above CPVC have a volume deficiency of resin in the mixture that is replaced by air. The relationship between CPVC, PVC and porosity is: porosity=CPVC/PVC. As used in this discussion of CPVC, the term “pigment” is equivalent to particles and the term “resin” is equivalent to binder. In certain binder-particle systems, when the volume concentration of the particles exceeds a critical value known, as the CPVC, the mixture becomes porous. Thus the coating becomes essentially a mixture of binder, particles, and air, because there is insufficient binder to fill all the gaps between the particles and the interstitial regions of the coating. When this occurs, the volume concentration is related to at least one of the pigment particle size distribution, wetting, and the particle structure or shape. Materials that provide desired low refractive index properties have submicron pores derived from particle-binder mixtures that are highly structured and formulated above their CPVC. In some embodiments, optical articles have CPVC values that are not greater than (or are less than) about 60%, or less than about 50%, or less than about 40%.

Particles that are highly branched or structured can prevent efficient packing in the binder matrix and can allow interstitial voids or pores to form. In contrast, material combinations which fall below the desired CPVC will not be sufficiently porous. The BET method (described herein) may be helpful in determining CPVC and thus porosity of low refractive index materials because the BET method analyzes pores that are less than 200 nm in diameter, less than 100 nm in diameter, or even less than 10 nm in diameter. As used herein, the term “BET method” refers to the Braunauer, Emmett, and Teller surface area analysis (See, for example, S. Brunauer, P. H. Emmett, and E. Teller, J. Am. Chem. Soc., 1938, 60, 309). The BET method is a well-known, scientifically validated method used to determine pore size, surface area, and percent porosity of a solid substance. BET theory relates to the physical adsorption of gas molecules on a solid surface and serves as the basis for obtaining physical information about the surface area and porosity of a solid surface. BET data can assist in the characterization of materials that meet minimum requirements for forming a porous structure.

The volume concentration of the particles described by the PVC/CPVC relationship is also related to the weight concentration of the particles. It is therefore, possible to establish particle weight ranges that are above the CPVC. The use of weight ratio or weight percent is one way to formulate mixtures with the desirable CPVC values. For the optical constructions of the present disclosure, weight ratios of binder to particle from 1:1 to 1:8 are desirable. A weight ratio of 1:1 is the equivalent of about 50 weight percent (wt %) particle, whereas 1:8 is equivalent to about 89 wt % particle. Exemplary binder to metal oxide particle ratios are less than 1:2 (less than 33% binder), less than 1:3, less than 1:4, less than 1:5, less than 1:6, less than 1:7, less than 1:8, less than 1:9, and less than 1:10 (about 8-10% binder). The upper limit of binder may be dictated by the desired refractive index. The lower limit of binder may be dictated by the desired physical properties, for example, processing or final durability characteristics. Thus the binder to particle ratio will vary depending on the desired end use and the desired optical article properties.

In general, the low refractive index layer can have any porosity, pore size distribution, or void volume fraction that may be desirable in an application. In some embodiments, the volume fraction of the plurality of the voids in the low refractive index layer is not less than about 20%, or not less than about 30%, or not less than about 40%, or not less than about 50%, or not less than about 60%, or not less than about 70%, or not less than about 80%.

In some embodiments, portions of the low refractive index layer can manifest some low refractive index properties, even if the low refractive index layer has a high optical haze and/or diffuse reflectance. For example, in such embodiments, the portions of the low refractive index layer can support optical gain at angles that correspond to an index that is smaller than the index n_{b} of the binder.

In some embodiments, some of the particles have reactive groups and others do not have reactive groups. For example in some embodiments, about 10% of the particles have reactive groups and about 90% of the particles do not have reactive groups, or about 15% of the particles have reactive groups and about 85% of the particles do not have reactive groups, or about 20% of the particles have reactive groups and about 80% of the particles do not have reactive groups, or about 25% of the particles have reactive groups and about 75% of the particles do not have reactive groups, or about 30% of the particles have reactive groups and about 60% of the particles do not have reactive groups, or about 35% of the particles have reactive groups and about 65% of the particles do not have reactive groups, or about 40% of the particles have reactive groups and about 60% of the particles do not have reactive groups, or about 45% of the particles have reactive groups and about 55% of the particles do not have reactive groups, or about 50% of the particles have reactive groups and about 50% of the particles do not have reactive groups. In some embodiments, some of the particles may be functionalized with both reactive and unreactive groups on the same particle. The ensemble of particles may include a mixture of sizes, reactive and non-reactive particles and different types of particles, for example, organic particles including polymeric particles such as acrylics, polycarbonates, polystyrenes, silicones and the like; or inorganic particles such as glasses or ceramics including, for example, silica and zirconium oxide.

In some embodiments, the low refractive index layers or material can have a BET porosity that is greater than about 30% (which corresponds to a surface area of about 50 m²/g as determined by the BET method), porosity greater than about 50% (which corresponds to a surface area of about 65-70 m²/g as determined by the BET method), greater than about 60% (which corresponds to a surface area of about 80-90 m²/g as determined by the BET method), and most preferably between about 65% and about 80% (which corresponds to a somewhat higher surface area of values greater than about 100 m²/g as determined by the BET method). In some embodiments, the volume fraction of the plurality of interconnected voids in the low refractive index layer is not less than (or is greater than) about 20%, or greater than about 30%, or greater than about 40%, or greater than about 50%, or greater than about 60%, or greater than about 70%, or greater than about 90%. Generally it can be shown higher surface areas indicated higher percent porosity and thus lower refractive index, however, the relationship between these parameters is complicated. The values shown here are only for purposes of guidance and not meant to exemplify a limiting correlation between these properties. The BET surface area and percent porosity values will be dictated by the need to balance the low refractive index and other critical performance properties such as cohesive strength of the coating.

The optical constructions of the present disclosure can have any desired optical haze. In some embodiments, low refractive index layer has an optical haze that is not less than (or is greater than) about 20%, or greater than about 30%, or greater than about 40%, or greater than about 50%, or greater than about 60%, or greater than about 70%, or greater than about 80%, or greater than about 90%, or greater than about 95%. In some embodiments, the low refractive index layer has a low optical haze. For example, in some embodiments, the optical haze of the low refractive index layer is less than about 20%, less than about 10%, less than about 5%, less than about 3%, less than about 2%, less than about 1.5%, or less than about 1%.

The low refractive index layer can include a polymeric protective layer. The polymeric protective layer can be a stable protective layer that does not substantially degrade the physical properties the low refractive index layer upon aging. The polymeric protective layer can include a binder that is also used in the low refractive index layer, and the binder can form a gradient from the low refractive index layer to the exterior surface of the polymeric protective layer. The protective layer can improve cohesive strength of a film construction having a low refractive index layer. Polymeric protective layers are disclosed, for example, in Applicants' provisional application, U.S. Ser. No. 61/617,842, entitled “Protective Coating for Low Index Material,” filed Mar. 30, 2012.

In some aspects a display device is provided that includes a photovoltaic cell, a dichroic reflector adjacent to the photovoltaic cell, a low refractive index layer having a refractive index of 1.4 or less adjacent to the dichroic reflector and a phosphor layer, a optically diffusive layer, or both optically coupled to the low refractive index layer. Details of the photovoltaic cell, the dichroic reflector, and the low refractive index layer are described above.

The provided display device can include one or more phosphor layers. Phosphors are well known to those of ordinary skill in the art of electronic displays and are, generally, substances that exhibit the phenomenon of luminescence. Phosphors include both phosphorescent materials which show a slow decay in brightness (around 1 millisecond) and fluorescent materials where the emission decay is very rapid (over tens of nanoseconds). Phosphors are often transition metal compounds or rare earth compounds of various types. Each phosphor can include a shutter layer that allows luminescence from the phosphor to be visible through the display layer or to be blocked so the luminescence is not visible through the display layer. Shutter layers and phosphors in reflective color display pixels are described in detail, for example, in PCT Pat. Appl. Publ. No. WO 2012/150921 A1 (Gibson et al.).

Pixels include luminescent arrays of blue-emitting, red-emitting, and green-emitting sub-pixels that have an electro-optical shutter disposed above each sub-pixel. The shutters can control the intensity of the emission from each sub-pixel. The shutter can be in the form of, for example, dichroic dye-liquid crystal guest-host systems, electrophoretic, electro-wetting, or electro-fluid cells. The shutters can be tuned from transparent through various shades of grey to opaque. The shuttles can control the transmission of ambient light to the luminescent layer and the dichroic mirror as well as the transmission of the subpanel towards the top surface.

The provided display can include an optically diffusive layer. Optically diffusive layers can diffuse incident light and can advantageously give a white appearance to optical constructions in, for example, daylight conditions. The optically diffusive layer can be any optically diffusive layer that may be desirable and/or available in an application. For example, the optically diffusive layer can include a plurality of particles dispersed in a binder where the particles and the binder have different indices of refraction. In some cases, such as when the optically diffusive layer is sufficiently optically diffusive to impart a white look to the optical construction of the display panel, the optically diffusive layer can have an optical haze that is not less than about 40%, or not less than about 50%, or not less than about 60%, or not less than about 70%, or not less than about 80%, or not less than about 90%, or not less than about 95%. In some cases, optically diffusive layers can also be an adhesive. In such cases, the optically diffusive layer can provide sufficient adhesion so that display panels may not need an additional optical adhesive.

In some embodiments, the display device can include a patterned display panel including a phosphor having a visible emission peak. The phosphor can be adjacent to the dichroic reflector. The reflective cutoff wavelength edge of the dichroic can substantially overlap the visible emission peak of the phosphor up to 750 nm. Patterned displays present an image to the viewer of the display. The patterning can be physical or electronic. Physical patterning includes having the display present in selective areas. Electronic patterning includes providing an image by the use of shutters and sub-pixels as described above.

The provided display devices can include an optical adhesive layer between its constitutive elements or to attach the display device to an electronic device. The optical adhesive layer can be any optical adhesive that may be desirable and/or available in an application. The optical adhesive layer should be of sufficient optical quality and light stability such that, for example, the adhesive layer does not yellow with time or upon exposure to weather so as to degrade the optical performance of the adhesive and the other components of the display device. In some cases, the optical adhesive layer can be a substantially clear optical adhesive meaning that the adhesive layer has a high specular transmittance and a low diffuse transmittance. For example, in such cases, the specular transmittance of the optical adhesive layer can be not less than about 70%, or not less than about 80%, or not less than about 90%, or not less than about 95%. In some cases, optical adhesive layer can be a substantially diffuse optical adhesive, meaning that the adhesive layer has a high diffuse transmittance and a low specular transmittance. For example, in such cases, the diffuse transmittance of the optical adhesive layer may not be less than about 60%, or not less than about 70%, or not less than about 80%. Exemplary optical adhesives include pressure sensitive adhesives (PSAs), heat-sensitive adhesives, solvent-volatile adhesives, repositionable adhesives or reworkable adhesives, and UV-curable adhesives such as UV-curable optical adhesives available from Norland Products, Inc.

Exemplary PSAs include those based on natural rubbers, synthetic rubbers, styrene block copolymers, (meth)acrylic block copolymers, polyvinyl ethers, polyolefins, and poly(meth)acrylates. As used herein, (meth)acrylic (or acrylate) refers to both acrylic and methacrylic species. Other exemplary PSAs include (meth)acrylates, rubbers, thermoplastic elastomers, silicones, urethanes, and combinations thereof. In some cases, the PSA is based on a (meth)acrylic PSA or at least one poly(meth)acrylate. Exemplary silicone PSAs include a polymer or gum and an optional tackifying resin. Other exemplary silicone PSAs include a polydiorganosiloxane polyoxamide and an optional tackifier.

In some case, the diffuse reflectance of an optically diffusive adhesive layer is not less than about 20%, or not less than about 30%, or not less than about 40%, or not less than about 50%, or not less than about 60%. In such cases, the adhesive layer can be optically diffusive by including a plurality of particles dispersed in an optical adhesive where the particles and the optical adhesive have different indices of refraction. The mismatch between the two indices of refraction can scatter light. In some cases, the optical adhesive layer can include cross-linked tackified acrylic pressure sensitive adhesives. The optical adhesive layer can also include additives such as tackifiers, plasticizers and fillers (such as pigments such as TiO₂). In some cases, TiO₂ can be added to the adhesive layer to give it a white appearance.

In one aspect, a display device is provided that includes a photovoltaic cell, a dichroic reflector adjacent to the photovoltaic cell, and a low refractive index layer adjacent to the dichroic reflector, where the low refractive index layer has a refractive index of between about 1.1 to about 1.4. In some embodiments, the spectrally selective reflector includes multiple polymeric layers and can be tuned so that it has an average transmission of greater than about 75% for wavelengths of electromagnetic radiation greater than about 750 nm along with an average reflection of greater than about 95% for wavelengths of electromagnetic radiation between 400 nm and 750 nm. In some embodiments, the display panel includes a patterned layer comprising a phosphor and in other embodiments the display panel can include a shutter layer. In some embodiments, the display device includes an optically diffusive layer.

The embodied display device can be laminated to a display layer of an electronic device such as personal data assistants, handheld phones, laptop computers, computer tablets, GPS monitors, electronic readers, or electronic billboards. The display layer of the electronic device can be a liquid crystal display device (LCD), an electrophoretic display, a transparent organic light-emitting diode (OLED) display, or an electroluminescent layer that has an average transmission of greater than 10% between 750 nm and 1500 nm. The display device can include at least one printed pattern with ink that can be absorbing ink, a dye, or an ink having an emission phosphor (phosphor layer). In some embodiments, the phosphor layer, dye, absorbing ink, or diffusive layer can be optically coupled to a low refractive index layer. The embodied display device is simple to manufacture and can be laminated directly onto electronic device displays without the need for additional frames or bezels for support. The low refractive index layer can allow the dichroic reflector to have a high reflection at high incident light angle.

In another aspect, a display device is provided that includes a photovoltaic cell, a dichroic reflector adjacent to the photovoltaic cell having a reflective cutoff wavelength edge, and a patterned display panel, where the patterned display panel includes a phosphor having a visible emission peak. The reflective cutoff wavelength edge substantially overlaps the visible emission peak of the phosphor up to 750 nm. The reflective cutoff wavelength edge substantially overlaps the visible emission peak of the phosphor. The photovoltaic cell can include silicon and the spectrally selective reflector can include multiple polymeric layers. The dichroic reflector can include an optically diffusive layer and a low refractive index layer.

In another aspect, a display device is provided that includes a photovoltaic cell, a dichroic reflector adjacent to the photovoltaic cell, where the dichroic reflector has a reflective cutoff wavelength edge, and a patterned display panel including a phosphor having a visible emission peak adjacent to the dichroic reflector. The reflective cutoff wavelength edge substantially overlaps the visible emission peak of the phosphor up to 750 nm. The reflective cutoff wavelength edge substantially overlaps the visible emission peak of the phosphor. The photovoltaic cell can include silicon and the spectrally selective reflector can include multiple polymeric layers. The dichroic reflector can include an optically diffusive layer and a low refractive index layer. In these embodiments of a display device, the shutter can be an electrophoretic shutter layer.

In yet another aspect, a display device is provided that includes a photovoltaic cell, a dichroic reflector adjacent to the photovoltaic cell, where the dichroic reflector has a reflective cutoff wavelength edge, and a patterned display panel comprising a phosphor having a visible emission peak adjacent to the dichroic reflector. The reflective cutoff wavelength edge of the dichroic reflector substantially overlaps the visible emission peak of the phosphor up to 750 nm.

The transmission and reflection should be measured with low refractive index layer or diffusive or diffusive plus low refractive index layer coupled with the dichroic mirror. Since the phosphor layer, if present, will be diffusive and change the spectrum of light, which depends on different phosphor, the measurement is made with a diffusive layer that doesn't have phosphor or pigment.

Useful embodiments of the provided display devices are illustrated in the following Figures. The embodiment illustrated in FIG. 2 includes photovoltaic cell 209, dichroic reflector 207 adjacent to photovoltaic cell 209, low refractive index layer 205 having a refractive index of between about 1.1 and 1.4 adjacent to dichroic reflector 207. Shutter layer 201 is disposed upon patterned layer 203 which, in turn, is adjacent to low refractive index layer 205.

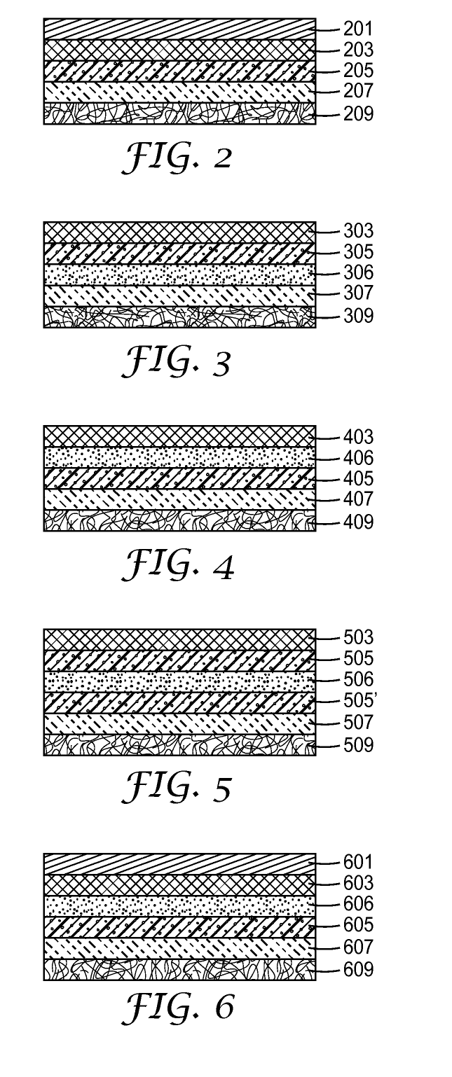

The embodiment illustrated in FIG. 3 includes patterned layer 303 disposed upon low refractive index layer 305 which is disposed upon diffusive layer 306. The diffusive layer 306 is disposed upon dichroic reflector 307, which is in turn disposed upon photovoltaic cell 309.

The embodiment illustrated in FIG. 4 is very similar to that illustrated in FIG. 3 except that the position of low refractive index layer and the diffusive layer have been exchanged. The embodiment illustrated in FIG. 4 includes patterned layer 403 disposed upon diffusive layer 406 which is disposed upon low refractive index layer 405. Low refractive index layer 405 is disposed upon dichroic reflector 407 and photovoltaic cell 409 as illustrated.

FIG. 5 illustrates an embodiment of a disclosed display device identical to that illustrated in FIG. 4 except that a second low refractive index layer sandwiches the diffusive layer. The embodiment illustrated in FIG. 5 has patterned layer 503 disposed upon first low refractive index layer 505 which is disposed upon diffusive layer 506. The diffusive layer 506 is disposed upon second low refractive index layer 505′. Low refractive index layer 505′ is disposed upon dichroic reflector 507 and photovoltaic cell 509 to complete the construction.

The embodiment of a disclosed display device shown in FIG. 6 is similar to the device illustrated in FIG. 4 except that a shutter is disposed upon a patterned layer. In FIG. 6, shutter layer 601 is disposed upon patterned layer 603, then diffusive layer 606, low refractive index layer 605, dichroic layer 607, and photovoltaic cell 609.

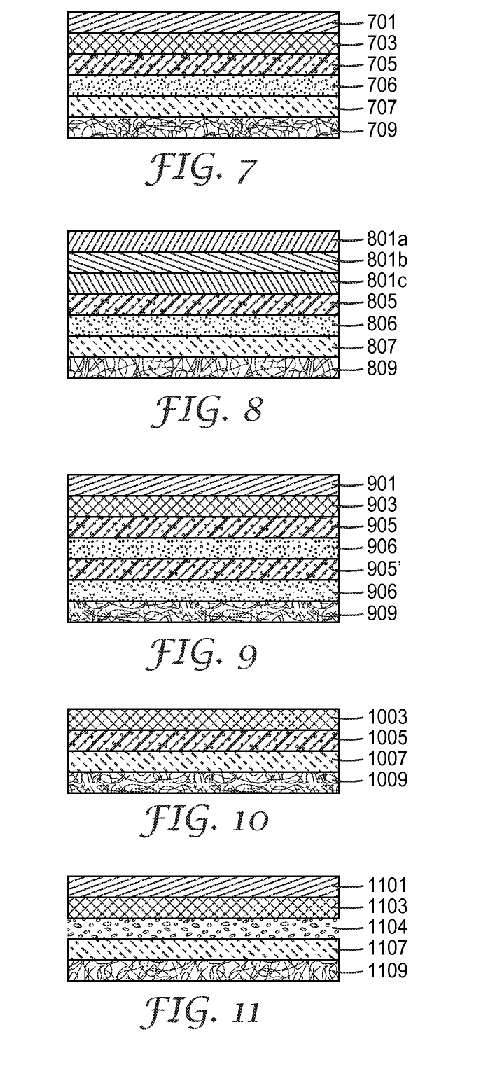

The embodiment illustrated in FIG. 7 is similar to the embodiment illustrated in FIG. 6 except that the position of the low refractive index layer and the diffusive layer have been exchanged. FIG. 7 shows shutter layer 701 disposed upon patterned layer 703. Low refractive index layer 705 is adjacent to patterned layer 703 and diffusive layer 706. Diffusive layer 706 is disposed upon dichroic layer 707 and photovoltaic cell 709 as shown.

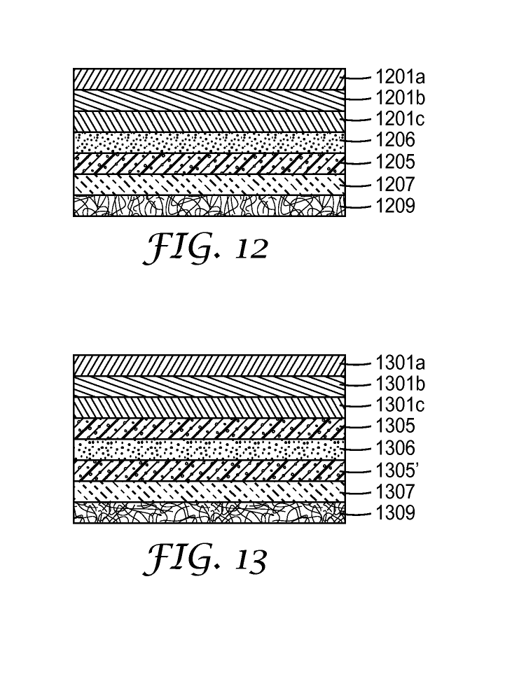

The embodiments illustrated in FIGS. 8 and 12 are similar except for the positional exchange of a low refractive index layer and a diffusive layer. In FIG. 8, three shutter layers are used. Red shutter layer 801a is disposed upon blue shutter layer 801b which is disposed upon green shutter layer 801c. Similarly, red shutter layer 1201a, blue shutter layer 1201b, and green shutter layer 1201C are used for the embodiment in FIG. 12. In FIG. 8, three shutter layers 801a, b, and c are disposed upon low refractive index layer 805, diffusive layer 806, dichroic reflector 807, and photovoltaic cell 809 respectively. In FIG. 12, three shutter layers 1201a, b, and c are disposed upon diffusive layer 1206 which is disposed upon low refractive index layer 1205, dichroic reflector 1207 and photovoltaic cell 1209.

The embodiment illustrated in FIG. 9 is similar to the embodiment illustrated in FIG. 5 except that a shutter layer has been added to the display device. Shutter layer 901 is disposed upon patterned layer 903, first low refractive index layer 905, diffusive layer 906, second low refractive index layer 905′, dichroic reflector 907, and photovoltaic cell 909.

The embodiment illustrated in FIG. 10 includes patterned layer 1003 disposed upon low refractive index layer 1005, dichroic reflector 1007, and photovoltaic cell 1009.

In the embodiment illustrated in FIG. 11, the low refractive index layer has been replaced by air (index of refraction about 1.00). Thus, in FIG. 11, shutter layer 1101 is disposed upon patterned layer 1103. Air gap 1104 is disposed between patterned layer 1103 and dichroic reflector 1107, which in turn is disposed upon photovoltaic cell 1109.

Finally, in the embodiment illustrated in FIG. 13, red shutter layer 1301a, blue shutter layer 1301b, and green shutter layer 1301c are disposed upon a sandwich of first low refractive index layer 1305, diffusive layer 1306, and second low refractive index layer 1305′. Second low refractive index layer 1305′ is disposed upon dichroic reflector 1307 and photovoltaic cell 1309.

The present disclosure is not meant to be limited by the embodiments illustrated in FIGS. 2-13. In the above description of FIGS. 2-13 it is understood that the term “disposed upon” is equivalent to the term “adjacent” and, as described herein, can include layers that can have one or more intervening layers between them.

Following are a list of embodiments of the present disclosure.

Item 1 a display device including a photovoltaic cell, a dichroic reflector adjacent to the photovoltaic cell, and a low refractive index layer adjacent to the dichroic reflector, where the low refractive index layer includes a refractive index of between about 1.1 to about 1.4.

Item 2 is the display device of item 1, wherein the photovoltaic cell includes silicon, copper indium gallium (di)selenide or a multijunction solar cell.

Item 3 is the display device of item 1, wherein the dichroic reflector includes multiple polymeric layers.

Item 4 is the display device of item 1, where the dichroic reflector has an average transmission of greater than about 75% for wavelengths of electromagnetic radiation greater than about 750 nm to about 2000 nm and an average reflection of greater than about 95% for wavelengths of electromagnetic radiation between 400 nm and 750 nm.

Item 5 is the display device of item 1, where the low refractive index layer includes a plurality of metal oxide particles, a binder, and a plurality of interconnected voids.

Item 6 is the display device of item 1, where the dichroic reflector includes a diffusive layer, a low refractive index layer, or a combination thereof.

Item 7 is a display device includes a photovoltaic cell, a dichroic reflector adjacent to the photovoltaic cell, a low refractive index layer adjacent to the dichroic reflector, where the low refractive index layer has a refractive index of 1.4 or less, and a phosphor layer, dye, absorbing ink, or a diffusive layer optically coupled to the low refractive index layer.

Item 8 is the display device of item 7, where the photovoltaic cell includes silicon.

Item 9 is the display device of item 7, where the dichroic reflector includes multiple polymeric layers.

Item 10 is the display device of item 7, where the dichroic reflector has an average transmission of greater than about 75% for wavelengths of electromagnetic radiation greater than about 750 nm to about 2000 nm and an average reflection of greater than about 95% for wavelengths of electromagnetic radiation between 400 nm and 750 nm.

Item 11 is the display device of item 7, where the dichroic reflector includes a diffusive layer, a low refractive index layer, or a combination thereof.

Item 12 is the display device of item 11, where the low refractive index layer includes a plurality of metal oxide particles, a binder, and a plurality of interconnected voids.

Item 13 is the display device of item 11, where the display device includes a phosphor.

Item 14 is the display device of item 13, where the phosphor is patterned.

Item 15 is the display device of item 7 where the display device includes a diffusive layer.

Item 16 is the display device of item 7, further including a shutter layer.

Item 17 is the display device of item 16, where further including a phosphor.

Item 18 is the display device of item 7, where the low refractive index layer does not contact the dichroic reflector.

Item 19 is the display device of item 7, where the dichroic reflector includes a diffusive layer disposed upon the low refractive index layer.

Item 20 is the display device of item 7, where the dichroic reflector includes a diffusive layer and a low refractive index layer, and where the low refractive index layer is sequentially disposed upon the diffusive layer.

Item 21 is the display device of item 13, where the phosphor has a visible emission peak and the reflector transmits visible light in a wavelength range from about 50 nm less than the emission peak of phosphor to about 750 nm.

Item 22 is a display device including a photovoltaic cell, a dichroic reflector adjacent to the photovoltaic cell having a reflective cutoff wavelength edge, a patterned display panel comprising a phosphor layer, a dye layer, an absorbing ink layer, or a diffusive layer having a visible emission peak adjacent to the dichroic reflector, where the reflective cutoff wavelength edge of the dichroic reflector substantially overlaps the visible emission peak of the phosphor up to 750 nm.

Item 23 is the display device of item 22, where the photovoltaic cell includes silicon.

Item 24 is the display device of item 22, where the dichroic reflector includes multiple polymeric layers.

Item 25 is the display device of item 22, wherein the patterned display panel is in contact with the dichroic reflector.

Item 26 is the display device of item 22, wherein the patterned display panel is disposed upon a transparent substrate.

Item 27 is the display device of item 22, wherein the dichroic reflector has a low refractive index layer disposed upon it.

Item 28 is the display device of item 27, wherein the dichroic reflector a diffusive layer disposed upon the low refractive index layer.

Item 29 is the display device of item 22, wherein the dichroic reflector includes a diffusive layer and a low refractive index layer, and wherein the low refractive index layer is sequentially disposed upon the diffusive layer.

Item 30 is an electronic device including the display device of item 1.

Item 31 is an electronic device including the display device of item 7.

Item 32 is an electronic device including the display device of item 22.

Objects and advantages of this disclosure are further illustrated by the following examples, but the particular materials and amounts thereof recited in these examples, as well as other conditions and details, should not be construed to unduly limit this disclosure. All references cited within are herein incorporated by reference in their entirety.

What is claimed is:

1. A display device comprising:
a photovoltaic cell;
a dichroic reflector adjacent to the photovoltaic cell; and
a low refractive index layer adjacent to the dichroic reflector, wherein the low refractive index layer has a refractive index of between about 1.1 to about 1.4.

2. A display device according to claim 1, wherein the photovoltaic cell comprises silicon, copper indium gallium (di)selenide or a multijunction solar cell.

3. A display device according to claim 1, wherein the dichroic reflector comprises multiple polymeric layers.

4. A display device according to claim 1, wherein the dichroic reflector has an average transmission of greater than about 75% for wavelengths of electromagnetic radiation greater than about 750 nm to about 2000 nm and an average reflection of greater than about 95% for wavelengths of electromagnetic radiation between 400 nm and 750 nm.

5. A display device according to claim 1, wherein the low refractive index layer comprises a plurality of metal oxide particles, a binder, and a plurality of interconnected voids.

6. A display device according to claim 1, wherein the dichroic reflector comprises a diffusive layer, a low refractive index layer, or a combination thereof.

7. A display device comprising:
a photovoltaic cell;
a dichroic reflector adjacent to the photovoltaic cell;
a low refractive index layer adjacent to the dichroic reflector, wherein the low refractive index layer has a refractive index of 1.4 or less; and
a phosphor layer, a dye layer, an absorbing ink layer, or a diffusive layer optically coupled to the low refractive index layer.

8. A display device according to claim 7, wherein the photovoltaic cell comprises silicon.

9. A display device according to claim 7, wherein the dichroic reflector comprises multiple polymeric layers.

10. A display device according to claim 7, wherein the dichroic reflector has an average transmission of greater than about 75% for wavelengths of electromagnetic radiation greater than about 750 nm to about 2000 nm and an average reflection of greater than about 95% for wavelengths of electromagnetic radiation between 400 nm and 750 nm.

11. A display device according to claim 7, wherein the dichroic reflector comprises a diffusive layer, a low refractive index layer, or a combination thereof.

12. A display device according to claim 11, wherein the low refractive index layer comprises a plurality of metal oxide particles, a binder, and a plurality of interconnected voids.

13. A display device according to claim 11, further comprising a phosphor.

14. A display device according to claim 13, wherein the phosphor is patterned.

15. A display device according to claim 7, further comprising a diffusive layer.

16. A display device according to claim 7, further comprising a shutter layer.

17. A display device according to claim 16, further comprising a phosphor.

18. A display device according to claim 7, wherein the low refractive index layer does not contact the dichroic reflector.

19. A display device according to claim 7, wherein the dichroic reflector comprises a diffusive layer disposed upon the low refractive index layer.

20. A display device according to claim 7, wherein the dichroic reflector comprises a diffusive layer and a low refractive index layer, and
wherein the low refractive index layer is sequentially disposed upon the diffusive layer.

21. A display device according to claim 13, wherein the phosphor has a visible emission peak and the reflector transmits visible light in a wavelength range from about 50 nm less than the emission peak of phosphor to about 750 nm.

22. A display device comprising:
a photovoltaic cell;
a dichroic reflector adjacent to the photovoltaic cell, wherein the dichroic reflector has a reflective cutoff wavelength edge; and
a patterned display panel adjacent to the dichroic reflector, wherein the patterned display panel comprises a phosphor having a visible emission peak;
wherein the reflective cutoff wavelength edge of the dichroic reflector substantially overlaps the visible emission peak of the phosphor up to 750 nm.

23. A display device according to claim 22, wherein the photovoltaic cell comprises silicon.

24. A display device according to claim 22, wherein the dichroic reflector comprises multiple polymeric layers.

25. A display device according to claim 22, wherein the patterned display panel is in contact with the dichroic reflector.

26. A display device according to claim 22, wherein the patterned display panel is disposed upon a transparent substrate.

27. A display device according to claim 22, wherein the dichroic reflector has a low refractive index layer disposed upon it.

28. A display device according to claim 27, wherein the dichroic reflector has a diffusive layer disposed upon the low refractive index layer.

29. A display device according to claim 22, wherein the dichroic reflector comprises a diffusive layer and a low refractive index layer, and wherein the low refractive index layer is sequentially disposed upon the diffusive layer.

30. An electronic device comprising the display device according to claim 1.

31. An electronic device comprising the display device according to claim 7.

32. An electronic device comprising the display device according to claim 22.
